(19) United States
(12) Patent Application Publication
(10) Pub. No.: US 2016/0150589 A1
(43) Pub. Date: May 26, 2016

(54) LEARNING NETWORK TIMEOUT VALUES DYNAMICALLY

(71) Applicant: QUALCOMM Incorporated, San Diego, CA (US)

(72) Inventors: Can ZHAO, San Diego, CA (US); Arnaud MEYLAN, San Diego, CA (US); Gerardo GIARETTA, San Diego, CA (US); Aziz GHOLMIEH, San Diego, CA (US)

(21) Appl. No.: 14/690,048

(22) Filed: Apr. 17, 2015

Related U.S. Application Data
(60) Provisional application No. 62/084,842, filed on Nov. 26, 2014.

(51) Int. Cl. H04W 76/04

(52) U.S. Cl. CPC H04W 76/045

(57) ABSTRACT

Methods, systems, and devices are described for passively and dynamically determining network timeout (NTO) values. The method may include adjusting an amount of delay applied to transmissions on an existing connection to a device in a network and determining how long the existing connection is allowed to remain idle before the existing connection expires based on the adjusting of the amount of delay applied to the transmissions on the existing connection.

### CROSS-REFERENCE TO RELATED APPLICATIONS

This application claims benefit of U.S. Provisional Patent Application Ser. No. 62/084,842, filed Nov. 26, 2014, which is expressly incorporated herein by reference.

### TECHNICAL FIELD

The present disclosure relates generally to wireless communication, and more particularly, to methods and apparatus for learning network timeout values dynamically.

### INTRODUCTION

The following relates generally to wireless communication, and more specifically to the detection of network timeout (NTO) values dynamically to maintain persistent connections. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple mobile devices. Base stations may communicate with mobile devices on downstream and upstream links. Each base station has a coverage range, which may be referred to as the coverage area of the cell. An application installed on a mobile device may establish a network connection over a wireless communication system. Keep-alive messages may be sent at certain time intervals to keep the network connection open. If multiple network connections are open, the mobile device may establish a radio connection a number of different times to transmit keep-alive messages for each connection. The establishment of multiple radio connections uses additional resources and power of the mobile device as well as additional network resources for signaling related to setting up and maintaining the connections.

### BRIEF SUMMARY

The described features generally relate to one or more improved systems, methods, and/or apparatuses for synchronizing the generation of keep-alive messages for a number of persistent connections. The keep-alive messages may perform the function of keeping a connection alive, and may additionally transport user plane information. While the methods are disclosed in conjunction with synchronizing the generation of keep-alive messages, the feature also applies in the absence of synchronization. However, less accurate learning is possible. In one aspect, multiple persistent connections may be established by one or more applications on a device. Keep-alive messages for the connections may be created and transmitted asynchronously or in a synchronized manner according to a keep-alive time interval of the network hosting the connections. A single radio connection may be established to transmit the keep-alive messages for the various connections. Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

A method for generating keep-alive messages for a plurality of persistent connections is described. The plurality of persistent connections associated with at least one application on a wireless device in a network hosting the plurality of persistent connections may be identified. A timing schedule specific to the network to transmit keep-alive messages to refresh each persistent connection of the plurality of persistent connections may be identified. A generation of the keep-alive messages for each persistent connection of the plurality of persistent connections may be synchronized. The synchronized generation of the keep-alive messages may occur according to the identified timing schedule of the network.

Synchronizing the generation of the keep-alive messages may include generating a keep-alive message for at least one persistent connection before a time indicated by the identified timing schedule. A first persistent connection of the plurality of persistent connections may originate from a first entity. A first keep-alive message to refresh the first persistent connection may originate from a second entity. The second entity may be different from the first entity.

In one configuration, a first persistent connection may be established between a first device and a second device in the network. A query may be transmitted after a first time period to determine whether the first persistent connection is available. The timing schedule to transmit the keep-alive messages to refresh persistent connections in the network may be identified based at least in part on the determination as to whether the first persistent connection is available.

In one configuration, upon determining the first persistent connection is unavailable after the first time period, a second persistent connection may be established between the first device and the second device in the network. A query may be transmitted after a second time period to determine whether the second persistent connection is available. In some configurations, the second time period may be shorter than the first time period. Upon determining the first persistent connection is available after the first time period, an additional query may be transmitted after a second time period to determine whether the first persistent connection is available. In some configurations, the second time period may be longer than the first time period.

In some aspects, the query to determine whether the first persistent connection is available originates from a modem processor or an application processor. Identifying the timing schedule may include identifying a network identifier (ID) of the network and querying a central database for timeout information of persistent connections established in the network. The query may be based at least in part on the network ID. Identifying the timing schedule may include determining whether the timeout information for persistent connections in the network exists in the central database.

Upon determining that the timeout information exists in the central database, the timing schedule to transmit the keep-alive messages to refresh the plurality of persistent connections in the network may be identified. The timing schedule may be based at least in part on the timeout information. Information identifying the identified timing schedule may be stored in a central database. The information may include an identifier (ID) of the network.

In some configurations, the keep-alive messages to refresh the plurality of persistent connections may be transmitted over a single radio connection according to the identified time schedule. The keep-alive messages may originate from a modem processor or an application processor. In some aspects, the network may include a wireless local area network (WLAN) or a cellular network. In some configurations, a persistent connection of the plurality of persistent connections may include a transmission control protocol (TCP) connection or a user datagram protocol (UDP) connection.

A wireless device configured to generate keep-alive message for a plurality of persistent connections is also described. The wireless device may include a processor, memory in electronic communication with the process, and instructions stored in the memory. The instructions may be executable by the processor to identify the plurality of persistent connections associated with at least one application on a wireless device in a network hosting the plurality of persistent connections. The instructions may be executable by the processor to identify a timing schedule specific to the network to transmit keep-alive messages to refresh each persistent connection of the plurality of persistent connections and synchronize a generation of the keep-alive messages for each persistent connection of the plurality of persistent connections. The synchronized generation of the keep-alive messages may occur according to the identified timing schedule of the network.

An apparatus to generate keep-alive messages for a plurality of persistent connections is also described. The apparatus may include means for identifying the plurality of persistent connections associated with at least one application on a wireless device in a network hosting the plurality of persistent connections. The apparatus may include means for identifying a timing schedule specific to the network to transmit keep-alive messages to refresh each persistent connection of the plurality of persistent connections and means for synchronizing a generation of the keep-alive messages for each persistent connection of the plurality of persistent connections. The synchronized generation of the keep-alive messages may occur according to the identified timing schedule of the network.

A computer program product for generating keep-alive messages for a plurality of persistent connections is also described. The computer program product may include a non-transitory computer-readable medium storing instructions executable by a processor to identify the plurality of persistent connections associated with at least one application on a wireless device in a network hosting the plurality of persistent connections. The instructions may be executable by the processor to identify a timing schedule specific to the network to transmit keep-alive messages to refresh each persistent connection of the plurality of persistent connections and synchronize a generation of the keep-alive messages for each persistent connection of the plurality of persistent connections. The synchronized generation of the keep-alive messages may occur according to the identified timing schedule of the network.

According to certain aspects, timeout information (i.e., network time out values) may be determined passively and dynamically. Thus, aspects of the present disclosure provide a method for determining network timeout values, which may include adjusting an amount of delay applied to transmissions on an existing connection to a device in a network and determining an amount of time the existing connection is allowed to remain idle before the existing connection expires based on the adjusting of the amount of delay applied to the transmissions on the existing connection.

Aspects of the present disclosure also provide an apparatus for determining network timeout values. The apparatus generally includes at least one processor configured to adjust an amount of delay applied to transmissions on an existing connection to a device in a network and determine an amount of time the existing connection is allowed to remain idle before the existing connection expires based on the adjusting of the amount of delay applied to the transmissions on the existing connection. The apparatus also may include a memory coupled with the at least one processor.

Aspects of the present disclosure also provide an apparatus for determining network timeout values. The apparatus generally includes means for adjusting an amount of delay applied to transmissions on an existing connection to a device in a network and means for determining an amount of time the existing connection is allowed to remain idle before the existing connection expires based on the adjusting of the amount of delay applied to the transmissions on the existing connection.

Aspects of the present disclosure provide a computer program product for detecting a network timeout (NTO) value comprising a computer-readable medium, having instructions stored thereon for adjusting an amount of delay applied to transmissions on an existing connection to a device in a network and determining an amount of time the existing connection is allowed to remain idle before the existing connection expires based on the adjusting of the amount of delay applied to the transmissions on the existing connection.

### BRIEF DESCRIPTION OF THE DRAWINGS

A further understanding of the nature and advantages of some embodiments of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a wireless communications system;

FIG. 2 is a block diagram of an exemplary wireless communications system that includes an example of a device, in accordance with the present systems and methods;

FIG. 3 is a block diagram of an example of a processor, in accordance with the present systems and methods;

FIG. 4 is a block diagram illustrating one embodiment of a persistent connection refresh module in accordance with the present systems and methods;

FIG. 5 is a block diagram illustrating one embodiment of various modules of a timing schedule identification module and a keep-alive generation module to determine a keep-alive timeout time period in a wireless communications system;

FIG. 6 is a block diagram of an exemplary wireless communications system that includes another example of a device in accordance with the present systems and methods;

FIG. 7 is a timing diagram for synchronization of keep-alive messages for persistent connections;

FIG. 8 is a block diagram of a communications system that may be configured for managing keep-alive messages in accordance with various embodiments;

FIG. 9 is a flowchart of a method for synchronizing a generation of keep-alive messages in accordance with various embodiments;

FIG. 10 is a flowchart of a method for generating keep-alive messages for a persistent connection in accordance with the present systems and methods;

FIG. 11 is a flowchart of a method for transmitting keep-alive messages using a single radio connection in accordance with various embodiments;

FIG. 12 is a flowchart of a method for determining a timing schedule for keep-alive messages in accordance with the present systems and methods.

FIG. 13 illustrates example operations for determining network timeout (NTO) values, in accordance with certain aspects of the present disclosure.

FIG. 14 illustrates a timeline for determining an NTO value for an existing connection.

FIG. 15 is a flowchart of a method for determining network timeout (NTO) values, in accordance with certain aspects of the present disclosure.

### DETAILED DESCRIPTION

Internet protocol (IP) hosts may be separated by stateful middleboxes which perform functions such as firewalling and network address translation (NAT). NATs may be deployed on a cellular network, local-area network (LAN), and wireless LAN (WLAN). A network state may be maintained until a keep-alive timer expires. If a long-lived connection (e.g., a persistent connection) such as transmission control protocol (TCP) or user datagram protocol (UDP) is used, a mobile device may ensure the middlebox maintains the network state to keep the connection open. Otherwise, if the keep-alive timer expires, the middlebox may clear the state, resulting in the long-lived connection failing, as the middlebox will drop packets that do not correspond to a remembered state. The mobile device may generate keep-alive messages to transmit to the middlebox to maintain a persistent connection. In some embodiments, multiple persistent connections may be established by at least one application. Keep-alive messages for these connections may be synchronously generated and transmitted. By synchronizing the generation and transmission of these messages, these messages may be transmitted to the middlebox of the network over a single radio connection. This allows the mobile device to conserve resources and reduce traffic over the network hosting the long-lived connections.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

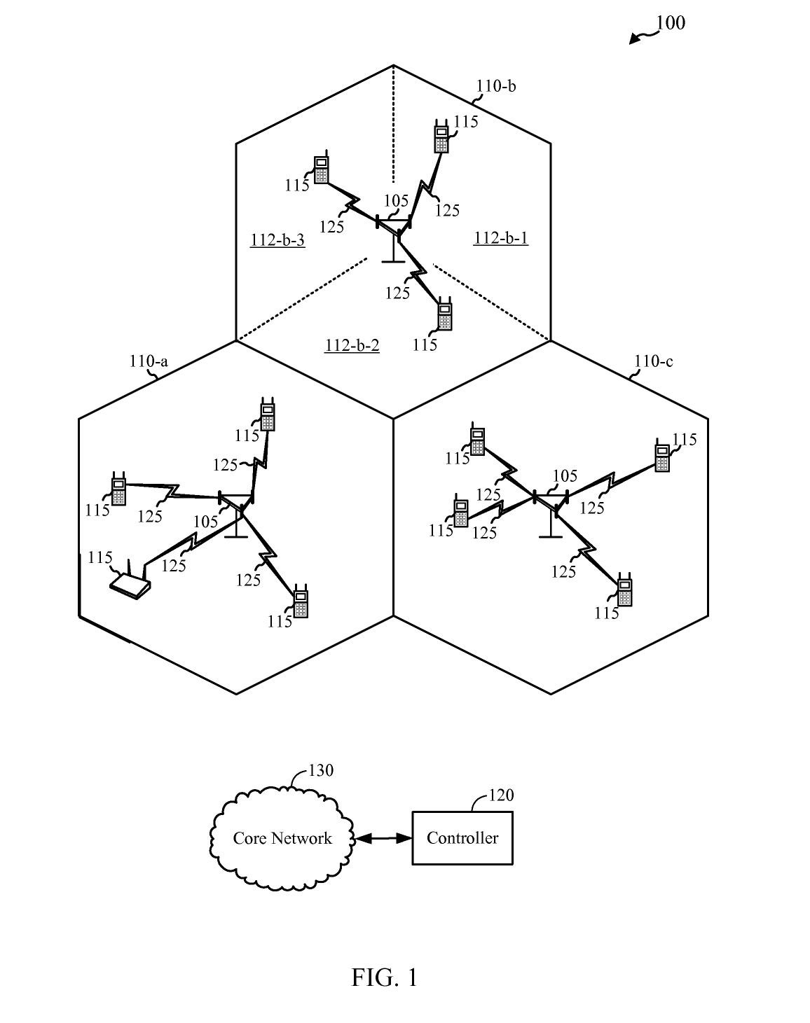

Referring first to FIG. 1, a block diagram illustrates an example of a wireless communications system 100. The wireless communications system 100 includes base stations 105 (or cells), communication devices 115, a network controller 120, and a core network 130 (the network controller 120 may be integrated into the core network 130). The wireless communications system 100 may support operation on multiple carriers (waveform signals of different frequencies). Multi-carrier transmitters can transmit modulated signals simultaneously on the multiple carriers. For example, each modulated signal may be a multi-carrier channel modulated according to the various radio technologies described herein. Each modulated signal may be sent on a different carrier and may carry control information (e.g., pilot signals, control channels, etc.), overhead information, data, etc. The wireless communications system 100 may be a multi-carrier LTE network capable of efficiently allocating network resources.

The base stations 105 may wirelessly communicate with the devices 115 via a base station antenna. The base stations 105 may communicate with the devices 115 under the control of the network controller 120 via multiple carriers. Each of the base station 105 sites may provide communication coverage for a respective geographic area. In some embodiments, base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area for each base station 105 here is identified as 110-a, 110-b, or 110-c. The coverage area for a base station may be divided into sectors making up only a portion of the coverage area (e.g., sectors 112-b-1, 112-b-2, 112-b-3, etc.). The wireless communications system 100 may include base stations 105 of different types (e.g., macro, micro, and/or pico base stations). There may be overlapping coverage areas for different technologies. A macro base station may provide communication coverage for a relatively large geographic area (e.g., 35 km in radius). A pico base station may provide coverage for a relatively small geographic area (e.g., 12 km in radius), and a femto base station may provide communication coverage for a relatively smaller geographic area (e.g., 50 m in radius). There may be overlapping coverage areas for different technologies.

The devices 115 may be dispersed throughout the coverage areas 110. Each device 115 may be stationary or mobile. In one configuration, the devices 115 may be able to communicate with different types of base stations such as, but not limited to, macro base stations, pico base stations, and femto base stations, via link 125. The devices 115 may be referred to as mobile stations, mobile devices, access terminals (ATs), user equipments (UEs), subscriber stations (SSs), or subscriber units. The devices 115 may include cellular phones and wireless communications devices, but may also include personal digital assistants (PDAs), other handheld devices, netbooks, notebook computers, tablet computers, etc.

In one example, the network controller 120 may be coupled to a set of base stations and provide coordination and control for these base stations 105. The network controller 120 may communicate with the base stations 105 via a backhaul (e.g., core network 130). The base stations 105 may also communicate with one another directly or indirectly and/or via wireless or wireline backhaul.

In accordance with some embodiments, the wireless communications system 100 may implement a keep-alive messaging system. A keep-alive message may be associated with a long-lived connection, or persistent connection (e.g., TCP, UDP) established by a device 115. A keep-alive message enables a device 115 to keep a persistent connection open with another device (e.g., a back-end server). For example, a device 115 may send a request to a server over a link 125 to open a persistent connection. The base station 105 may transmit the request to the server. The server may reply to the request from the device 115 and establish the persistent connection with the device 115. The device 115 may transmit keep-alive messages at certain time intervals to keep the persistent connection active.

Different networks that are used by persistent connections may have different timing schedules for how often keep-alive messages should be sent to maintain the connections. Devices 115 may not know the keep-alive timing schedule for the network that is hosting a persistent connection. Thus, devices 115 may send keep-alive messages more frequently than is needed in order to refresh connections causing increased battery drain for the devices 115, data usage for the device users, and additional traffic over the network. The present systems and methods may identify a keep-alive timing schedule for a network hosting a persistent connection. In addition, the present systems and methods may synchronize a generation of a number of keep-alive messages for a number of persistent connections on behalf of at least one application that opened the connections. Multiple keep-alive messages may be transmitted over a single radio connection to further conserve resources of the device 115.

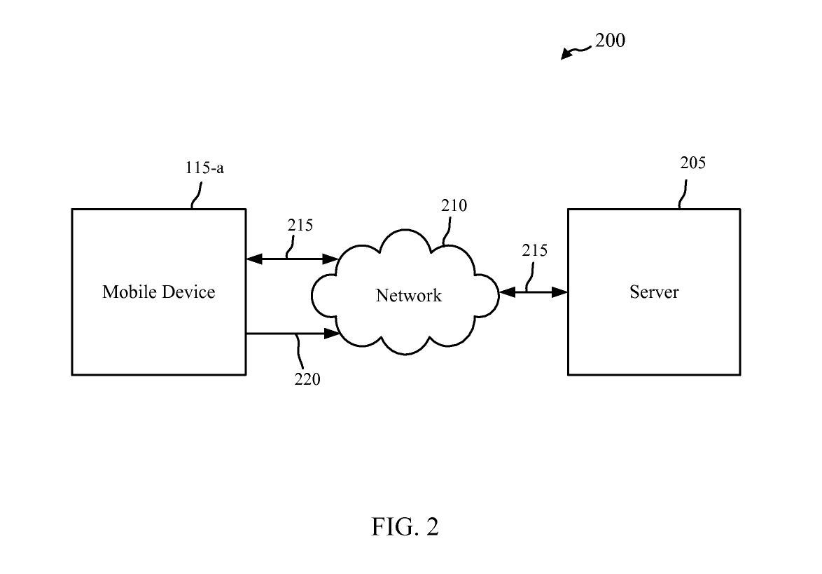

FIG. 2 is a block diagram of an exemplary wireless communications system 200, in accordance with the present systems and methods. A mobile device 115-a may communicate with a server 205 across a network 210. The mobile device 115-a may be an example of the device 115 depicted in FIG. 1. One example of the server 205 may include a server using TCP and/or UDP transport protocols. Thus, the depicted network 210 may include a TCP and/or a UDP network. Additionally or alternatively, the network 210 may include a WLAN and/or a cellular network. In one configuration, the server 205 (e.g., a destination server) may provide a crowd-sourcing access functionality, where a device 115-a may be granted access to read and write data on the server 205. In some cases, another server (different than the server 205) may provide crowd-sourcing access functionality.

In one embodiment, the device 115-a may establish a persistent (or long-lived) connection 215 with the server 205. The device 115-a may also send a keep-alive message 220 to maintain the persistent connection 215. In one configuration, the mobile device 115-a may initiate a process to establish the persistent connection 215 over the network 210 between the device 115-a and the server 205. The persistent connection 215 may be a TCP and/or UDP connection.

The device 115-a may create and transmit a keep-alive message 220 before a keep-alive timeout expires in order to maintain the persistent connection 215. The term keep-alive timeout may refer to a maximum amount of time after which a network middlebox may clear the state for a persistent connection between two devices. Without a keep-alive message, the middlebox (e.g., an intermediate NAT-enabled router) may drop the state associated with a long-lived connection when the keep-alive timeout expires. Different networks may use different keep-alive timeout values. In one embodiment, the mobile device 115-a may learn the value of a keep-alive timeout associated with the network 210.

In one configuration, the network 210 includes a stateful network. A stateful network may be any network that performs stateful packet inspection (SPI) or dynamic packet filtering to track the state of network connections (e.g., TCP streams and/or UDP communication) traveling across it. In a stateful network, also known as a firewall, when a packet is sent out of a computer in the network, the device 115-a, network 210, and/or server 205 may keep track of each packet. When a packet traverses the network 210, the device 115-a, network 210, and/or server 205 may determine whether or not an in-bound packet is a reply to a packet that was sent out. Thus, the network 210 may distinguish legitimate packets for different types of connections. The network 210 may allow those packets matching a known active connection (e.g., the persistent connection 215) while others may be rejected. The configuration is network specific. To associate a configuration with a network there is a need to identify the network with a network identifier. Methods to identify a network include: 1) using the public land mobile network (PLMN) identity, a mobile country code (MCC), a mobile network code (MNC), and/or a tracking area, 2) using an IP address or IP address prefix, 3) using geographical coordinates, 4) using access network identifier such as MAC address, Cell Identifier, and/or 5) using the technology type of the access network such as IEEE WLAN, UMTS, LTE. In addition, the network time out (NTO) value may be specific to a internet protocol version, transport protocol type, destination port number and/or a destination server identifier. The destination server identifier may be the internet address, the domain name of the server, the name or process identifier of the application originating traffic towards server 205.

In some embodiments, the device 115-a may store attributes of the persistent connection 215 in a memory device. Such attributes may be collectively known as the state of the connection, and may include such details as the IP addresses and ports involved in the persistent connection 215 and the sequence numbers of the packets traversing the persistent connection 215. Thus, over time the device 115-a, network 210, and/or server 205 may monitor incoming and outgoing packets traversing the persistent connection 215, as well as the state of the persistent connection 215, and store the data in dynamic state tables that are stored in a memory device. The device 115-a may evaluate this cumulative data to base filtering decisions on context that has been built by previous connections as well as previous packets belonging to the same connection. An entry in the data base may include a network identifier, a port number, a transport protocol type, a network timeout (NTO) interval and a destination server identifier.

In some embodiments, the keep-alive message 220 may originate from a modem processor or an application processor. A keep-alive may be a message sent by the device 115 to another device (such as the server 205) to verify that the persistent connection 215 between the two devices is still alive and/or to prevent the persistent connection 215 from being lost. In one configuration, the keep-alive message may contain null data. In one configuration, the device 115-a may originate multiple persistent connections which may be associated with a plurality of applications. Thus, in some embodiments, the device 115-a may generate a number of keep-alive messages for the persistent connections. In some embodiments, the generation and transmission of keep-alive messages for multiple connections may be synchronized.

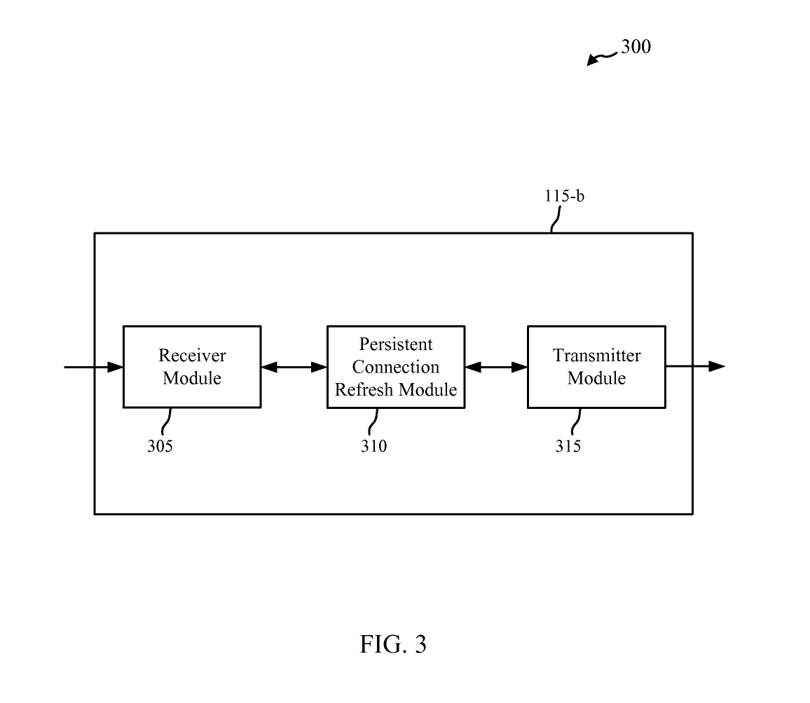

FIG. 3 is a block diagram 300 illustrating one embodiment of a mobile device 115-b, in accordance with the present systems and methods. The device 115-b may be an example of the mobile device 115 of FIGS. 1 and/or 2. The mobile device 115-b may include a receiver module 305, a persistent connection refresh module 310, and a transmitter module 315. Each of these components may be in communication with each other.

These components of the device 115-b may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In one configuration, the receiver module 305 may include a wireless receiver and may receive responses to requests to connect to a base station 105. The persistent connection refresh module 310 may learn the keep-alive timeout value for a network and generate keep-alive messages for persistent connections (e.g., persistent connection 215 in FIG. 2) using the network according to the learned keep-alive timeout value.

In one configuration, the device 115-b may transmit a request to establish a persistent connection over a particular network via the transmitter module 315. With a persistent connection established, the device 115-b may generate and transmit keep-alive messages to traverse through a network middlebox via the transmitter module 315 in a synchronized fashion. The persistent connection refresh module 310 may transmit multiple keep-alive messages for different connections over a single radio connection established by the transmitter module 315. Details regarding the persistent connection refresh module 310 are described below.

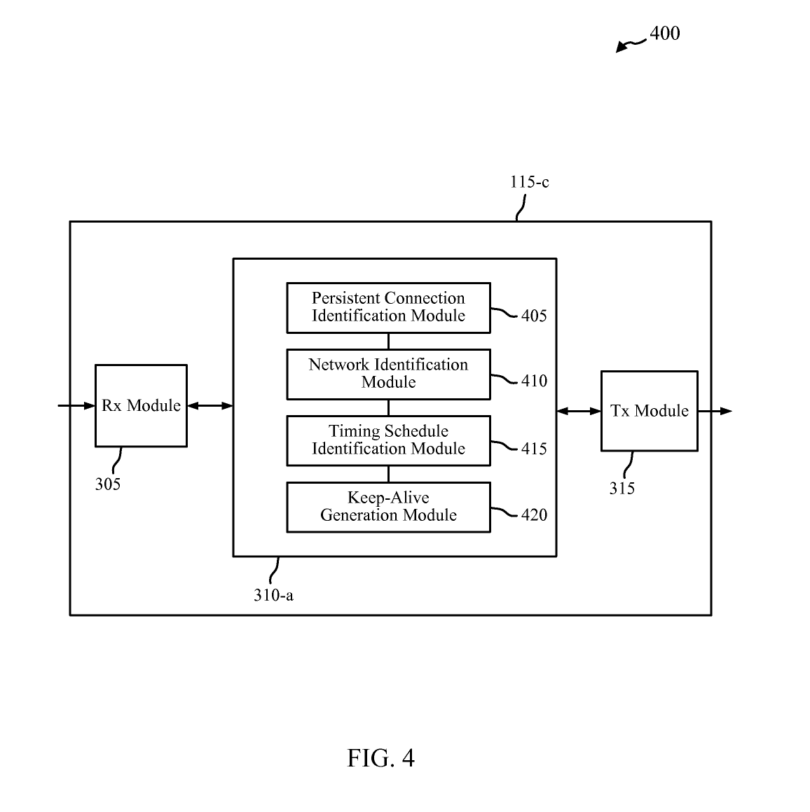

FIG. 4 is a block diagram 400 illustrating one embodiment of a persistent connection refresh module 310-a of a mobile device 115-c. The device 115-c may be an example of the mobile device 115 of FIGS. 1, 2, and/or 3. The persistent connection refresh module 310-a may be an example of the persistent connection refresh module 310 described in FIG. 3. The persistent connection refresh module 310-a may be in communication with a receiver module 305 and a transmitter module 315. In one embodiment, the persistent connection refresh module 310-a may include a persistent connection identification (ID) module 405, a network ID module 410, a timing schedule ID module 415, and a keep-alive generation module 420. Each of these components may be in communication with each other.

These components of the device 115-c may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In one configuration, the receiver module 305 may receive a message in response to a request to establish a persistent connection 215 to a server 205 that was transmitted via the transmitter module 315. The persistent connection ID module 405 may identify a number of persistent connections associated with at least one application on a wireless device in a network hosting the multiple persistent connections. The network ID module 410 may identify a network ID of the network hosting the connections.

The timing schedule ID module 415 may identify a timing schedule specific to the network hosting the connections. For example, the timing schedule ID module 415 may identify a timing schedule specific to the network that indicates how often keep-alive messages should be transmitted to refresh persistent connections. The keep-alive generation module 420 may generate a keep-alive message for at least one persistent connection before keep-alive timeout value expires indicated by the identified timing schedule. Details regarding the timing schedule ID module 415 and the keep-alive generation module 420 will be described below.

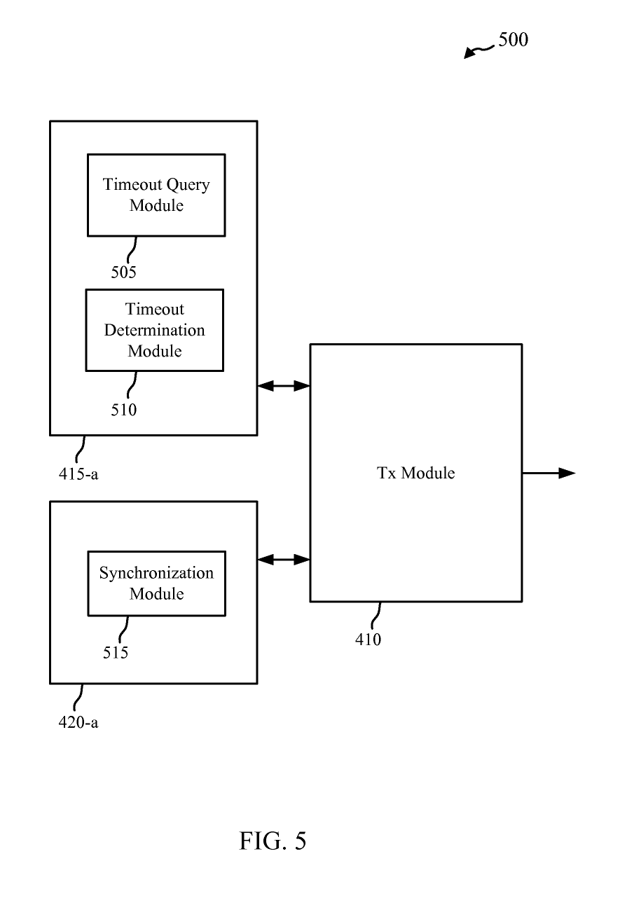

FIG. 5 is a block diagram 500 illustrating one embodiment of various modules of a timing schedule ID module 415-a and a keep-alive generation module 420-a to determine a keep-alive timeout value for a network and to generate keep-alive messages in accordance with the timeout value. The modules 415-a and 420-a may be examples of the timing schedule ID module 415 and the keep-alive generation module 420 described in relation to FIG. 4. Each of these components may be in communication with each other.

These components may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In one embodiment, the timing schedule ID module 415-a may include a timeout query module 505 and a timeout determination module 510. The timeout query module 505 may transmit a query after a predetermined time period to determine whether a persistent connection is available. For example, after a predetermined time period the timeout query module 505 may transmit a query to a server (such as server 205) to determine whether a persistent connection is available. In some embodiments, the timeout determination module 510 may determine whether the timeout information for one or more persistent connections in a network hosting the persistent connection is stored in a central database. In some embodiments, upon determining that the timeout information exists in a central database, the timeout determination module 510 may use this information to identify the timing schedule to transmit the keep-alive messages.

In some embodiments, if keep-alive timeout information for a network is unavailable in a central database, the timeout determination module 510 may learn the timeout information for the network. In one example, the timeout determination module 510 may establish a test persistent connection with a test device, such as a test server. The timeout query module 505 may transmit a query after a first period of time to determine whether the test connection is still available. If the connection is unavailable (e.g., the connection has terminated), the timeout determination module 510 may establish a second test persistent connection between the mobile device 115 and the test device. The timeout query module 505 may transmit a query after a second time period to determine whether the second persistent connection is available. In one configuration, the second time period may be shorter than the first time period.

In some embodiments, if the timeout determination module 510 determines the first test persistent connection is available after the first time period, the timeout query module 505 may transmit an additional query after a second time period to determine whether the first persistent connection is available. In one configuration, the second time period may be longer than the first time period. In some embodiments, the query to determine whether the first persistent connection is available may originate from a modem processor and/or an application processor of the device 115.

In one configuration, the timeout determination module 510 may estimate the value of the keep-alive timeout using a keep-alive timeout algorithm. The timeout determination module 510 may set a predetermined timing value, Tmax, to be an upper-bound of timeout values. In cooperation with the timeout determination module 510, the algorithm may initialize the keep-alive timing estimate to Tmax. The algorithm may establish a connection with another IP host (e.g., device 115 and/or server 205). After waiting the allotted period of time of the initial keep-alive timing estimate (i.e., Tmax), the algorithm may query the other IP host. If the established connection to the other IP host is still alive, the algorithm may return the current value of the initial keep-alive timing estimate. If the connection to the other IP host is not alive following the query, the algorithm may decrement the initial keep-alive timing estimate by a predetermined timing step-size. The algorithm may then setup a second connection with the other IP host. The algorithm may then wait a shorter period of time of the updated keep-alive timing estimate before poking the other IP host.

In one example, the keep-alive generation module 420-a may include a synchronization module 515. In one embodiment, the synchronization module 515 may synchronize the transmission of the keep-alive messages from each persistent connection of a number of persistent connections based on the timing information determined by the timeout determination module 510. The synchronized transmission of the keep-alive messages may occur according to the identified timing schedule of the network hosting the connections. Additional details regarding the synchronized transmission of keep-alive messages will be described below.

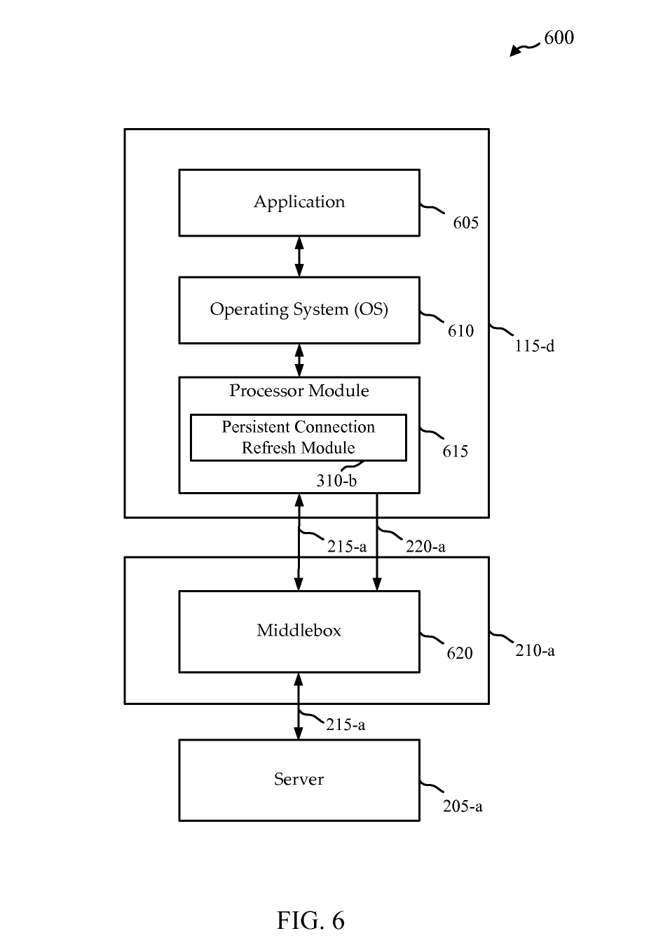

FIG. 6 is a block diagram of an exemplary wireless communications system 600 that includes another example of a device 115-d in accordance with the present systems and methods. The device 115-d may be an example of the device 115 depicted in FIGS. 1, 2, 3, and/or 4. The device 115-d may include an application 605, an operating system (OS) 610, and a processor 615. In addition to the device 115-d, the wireless communications system 600 may include a network 210-a and a server 205-a. The network 210-a and server 205-a may be examples of the network 210 and server 205 depicted in FIG. 2. The network 210-a may include a middlebox 620. Each of these components may be in communication with each other.

These components, individually or collectively, may be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In one embodiment, the application 605 may initiate a process to establish a persistent connection 215-a with the server 205-a. Examples of applications 605 that may request a persistent connection with the server 205-a may include, but are not limited to, MEEBO®, GOOGLE TALK®, SKYPE®, and the like. The request to establish the connection may pass through the OS 610. The OS 610 may include operating systems such as WINDOWS® and MAC-OS®. Additionally or alternatively, the OS 610 may include a mobile operating system such as ANDROID®, IOS®, BLACKBERRY®, WINDOWS PHONE®, or another similar mobile operating system. The OS 610 may provide a combination of functions and interfaces for the device 115-d. For example, the OS 610 may provide the device 115-d with functions and interfaces for a touchscreen, cellular connectivity, Bluetooth, wireless (Wi-Fi, 802.11), global positioning system (GPS) mobile navigation, camera, video camera, speech recognition, voice recorder, music player, near field communication (NFC), personal digital assistant (PDA), and other similar functions. In one embodiment, the OS 610 may provide an environment for applications, such as the application 605, to execute on the device 115-d.

One example of the processor 615 may include a modem processor. Alternatively, or additionally, one example of the processor 615 may include an application processor. In one configuration, the processor may include a persistent connection refresh module 310-b, which is an example of the persistent connection refresh module 310 illustrated in FIGS. 3 and/or 4. Additionally, or alternatively, the operating system 610 may include at least a portion of the persistent connection refresh module 310-b. In some embodiments, the persistent connection refresh module 310-b may establish a persistent connection 215-a between the device 115-d and the server 205-a over the network 210-a. In relation to the persistent connection 215-a, the persistent connection refresh module 310-b may generate a keep-alive message 220-a and transmit the keep-alive message 220-a to the middlebox 620 to maintain the persistent connection 215-a. In some embodiments, the persistent connection refresh module 310-b may transmit the keep-alive message 220-a to refresh the persistent connection 215-a. While a single persistent connection is illustrated, it is to be understood that multiple persistent connections may exist and multiple keep-alive messages may be generated to refresh the persistent connections. The multiple keep-alive messages may be generated in a synchronized manner and transmitted over a single radio connection according to an identified time schedule of the network 210-a hosting the connections.

In some embodiments, the persistent connection refresh module 310-b may provide a persistent connection service to the application 605. This service may include coordinating the generation and sending of keep-alive messages according to a keep-alive timing schedules for different networks. The application 605 may generate a request (e.g., opening a socket) to the persistent connection refresh module 310-b. When the persistent connection refresh module 310-b detects the request, the persistent connection refresh module 310-b may perform the functions of generating keep-alive messages on behalf of the application 605.

In some configurations, the persistent connection refresh module 310-b may learn a keep-alive timing schedule for the network 210-a. In one example, the persistent connection refresh module 310-b may set up the persistent connection 215-a with the server 205-a in the network 210-a. The server may respond with information indicating when the persistent connection refresh module 310-b should transmit a query back to the server to verify whether the persistent connection is available. At a suggested time provided by the server 205, the persistent connection refresh module 310-b may transmit a query on the persistent connection 215-a to check whether the connection is still alive. In another example, at the suggested time, the server 205 may transmit a query to the persistent connection refresh module 310-b to verify whether the connection is still alive. If the persistent connection refresh module 310-b determines that the connection is down, the persistent connection refresh module 310-b may establish another persistent connection with the server 205 through the middlebox 620. The persistent connection refresh module 310-b may transmit a query at a time interval that is shorter than the time interval in which the previous query was transmitted. For example, the persistent connection refresh module 310-b may transmit a query 30 minutes after the first persistent connection is established with the server 205. If the connection is unavailable, the persistent connection refresh module 310-b may establish a second persistent connection and transmit a query after 15 minutes to check whether the second connection is available. If the second connection is available, the persistent connection refresh module 310-b may now wait 20 minutes to transmit another query. This process may continue until the persistent connection refresh module 310-b learns a time interval in which queries can be sent and the connection is still alive. When this time interval is learned, the persistent connection refresh module 310-b may use this time interval as the timing schedule to send keep-alive messages for future persistent connections established in the network 210-a.

The persistent connection refresh module 310-b may update a central database with this timing schedule information. For example, the persistent connection refresh module 310-b may transmit the timing schedule information to a crowd-sourcing server, which may then add the information to the central database. The persistent connection refresh module 310-b may also add the information directly to the central database. When additional mobile devices enter the network 210-a, they may query the central database directly to discover the timing schedule to transmit keep-alive messages for persistent connections using the network 210-a. In another example, the additional mobile devices may transmit an identifier (ID) of the network to the crowd-sourcing server. The crowd-sourcing server may use the network ID to look-up the timing schedule of the network 210-a in the central database. The crowd-sourcing server may then return the timing schedule information to the additional mobile devices. By querying the central database, mobile devices may bypass the process of learning the keep-alive timing schedule for the network 210-a.

In one configuration, the middlebox 620 may be a computer networking device that transforms, inspects, filters, or otherwise manipulates traffic for purposes other than packet forwarding. Examples of middleboxes may include firewalls, which filter unwanted or malicious traffic, intrusion detection systems, which monitor traffic and collect data for security anomalies, network address translators (NATs), which modify packets source and destination addresses, and wide-area network (WAN) optimizers, which improve bandwidth consumption and perceived latency between dedicated endpoints. NATs are often deployed in cellular and local area networks (LANs) and wireless LANs (WLANs). In one configuration, the middlebox 620 may maintain the state until a timer expires. If the timer expires, the middlebox 620 may clear the state of the persistent connection 215-a and the persistent connection 215-a may close, as the middlebox 620 may drop packets that do not correspond to any state maintained by the middlebox 620.

In one configuration, the middlebox 620 may be a stateful middlebox. Devices (e.g., device 115-d and/or server 205-a) communicating over a stateful network (e.g., network 210-a) may be separated by stateful middleboxes. In some embodiments, the middlebox 620 may maintain a stateful network connection when either of two or more devices (e.g., the device 115-d and the server 205-a) transmits a message (or other traffic) on a persistent connection 215-a before a keep-alive timeout expires.

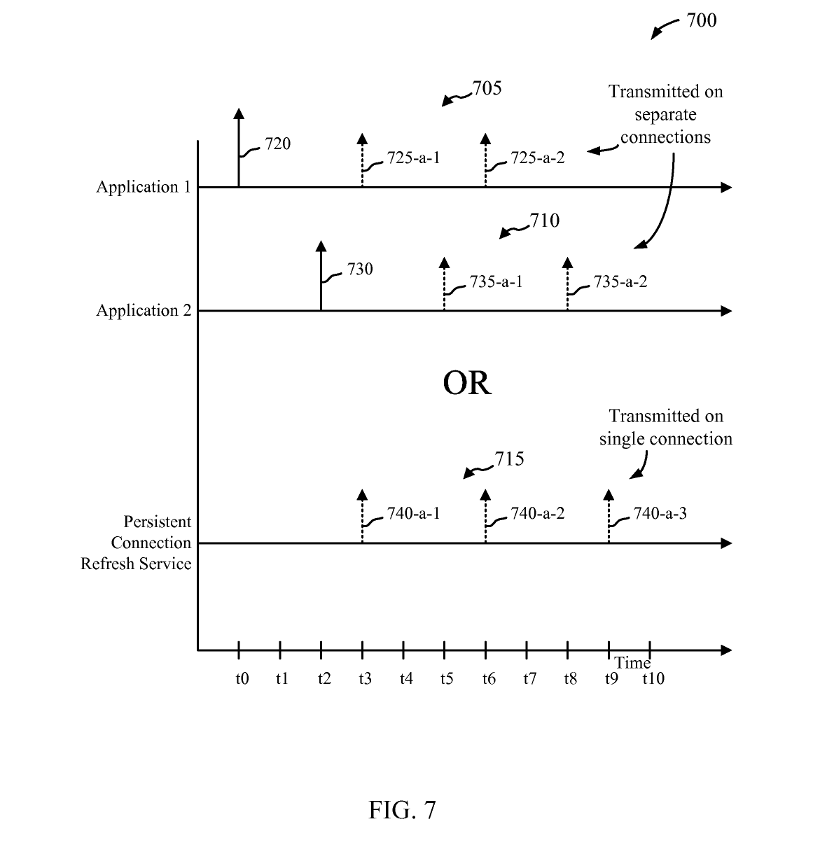

FIG. 7 is a timing diagram 700 illustrating the synchronization of keep-alive messages for persistent connections in accordance with the present systems and methods. The timing diagram 700 includes a time signature 705 for application 1, a time signature 710 for application 2, and a time signature 715 for a persistent connection refresh service. Applications 1 and 2 may be examples of the application 605 illustrated in FIG. 6. The persistent connection refresh service may be provided by the persistent connection refresh module 310 described in relation to FIGS. 3, 4, and/or 6. The time signatures 705 and 710 of applications 1 and 2 may occur when the persistent connection services provided by the persistent connection refresh module 310 are not used.

In one example, the time signature of application 1 may include a first persistent connection 720, a first keep-alive message 725-a-1, and a second keep-alive message 725-a-2. Application 1 may establish the first persistent connection 720 between a device 115 and a server 205 across the network 210. Over time, keep-alive messages 725-a-1 and 725-a-2 may be sent to the network middlebox 620 to keep the first persistent connection 720 alive.

The time signature 710 of application 2 may include a second persistent connection 730, a third keep-alive message 735-a-1, and a fourth keep-alive message 735-a-2. Similar with regards to the time signature 705, application 2 may establish the second persistent connection 730 between the same device 115 and server 205 using the network 210. Keep-alive messages 735-a-1 and then 735-a-2 may be sent to the middlebox 620 to keep the second persistent connection 730 alive. Separate radio connections may be established to transmit the keep-alive messages generated in the time signatures 705 and 710 of applications 1 and 2, respectively. Using separate radio connections to transmit these messages may result in the 115 experiencing an increase in the battery drain, data usage, and the source of additional traffic over the network 210.

The time signature 715 illustrates the time signature when the services provided by the persistent connection refresh module 310 are applied to the traffic of the applications 1 and 2. The time signature 715 may include a first synchronized keep-alive message 740-a-1, a second synchronized keep-alive message 740-a-2, and a third synchronized keep-alive message 740-a-3. In one embodiment, instead of both applications 1 and 2 generating and sending keep-alive messages 725 and 735, persistent connection refresh service may estimate the value of the keep-alive timeout and send keep-alive messages 725 and 735 at the time of the keep alive messages 740. Thus, in some configurations, a first persistent connection may originate from a first entity (e.g., application 1 and/or 2), and a first keep-alive message to refresh the first persistent connection may originate from a second entity (e.g., the persistent connection refresh module 310). For example, application 1 may establish the first persistent connection 720 at a time t0. Without the use of the persistent connection refresh service, application 1 may generate ant transmit over the wireless medium keep-alive messages 725-a-1 and 725-a-2 at times t3 and t6 according to the timing schedule of the network hosting the first persistent connection 720. Application 1 may then open radio connections to transmit the keep-alive messages 725 at times t3 and t6. Similarly, application 2 may establish the second persistent connection 730 at time t2. To maintain the second persistent connection 730, application 2 may generate and transmit over the wireless medium keep-alive messages 735-a-1 and 735-a-2 and open additional radio connections to transmit the keep-alive messages at times t5 and t8. Thus, without the use of the persistent connection refresh service, from time t0 to time t8 four radio connections may be established for applications 1 and 2 at times t3, t5, t6, and t8.

Using the persistent connection refresh service provided by the persistent connection refresh module 310 may reduce the number of radio connections. In this example, by synchronizing the transmission of the keep-alive messages for the first persistent connection 720 and the second persistent connection 730, the number of radio connections may be reduced. In one embodiment, from time t0 to time t8, a radio connection may be generated for the persistent connections of both applications 1 and 2 in a synchronized manner at time t3 and then again at time t6. Thus, instead of using two separate persistent connections (e.g., 720 and 730) to send keep alive messages, by using the persistent connection refresh service to generate keep-alive messages on behalf of applications 1 and 2, the number of radio connections may be reduced to a single radio connection established at times t3 and t6 for both applications 1 and 2 to transmit keep-alive messages 740 for both persistent connections 720 and 730.

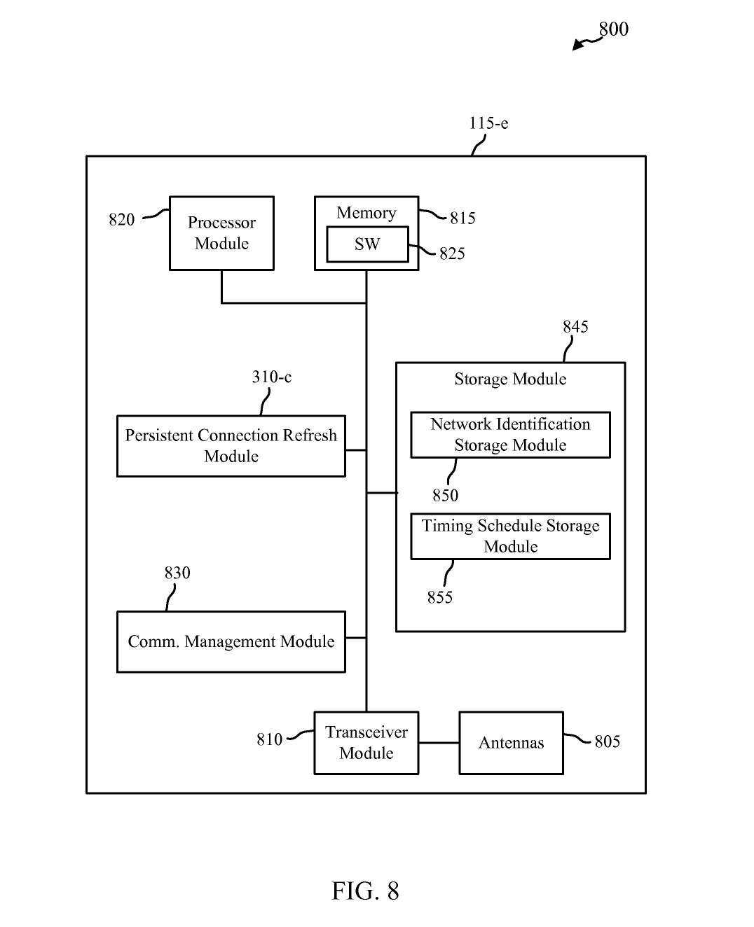

Turning now to FIG. 8, a block diagram 800 illustrates a mobile device 115-e that manages the generation of keep-alive messages in accordance with various embodiments. The mobile device 115-e may have any of various configurations, such as personal computers (e.g., laptop computers, netbook computers, tablet computers, etc.), cellular telephones, PDAs, digital video recorders (DVRs), internet appliances, gaming consoles, e-readers, etc. The mobile device 115-e may have an internal power supply (not shown), such as a small battery, to facilitate mobile operation. In some embodiments, the mobile device 115-e may be an example of the device 115 of FIGS. 1, 2, 3, 4, and/or 6. The mobile device 115-e may be a multi-mode mobile device. The mobile device 115-e may be referred to as a wireless communications device, user equipment (UE), etc. in some cases.

The mobile device 115-e may include antennas 805, a transceiver module 810, memory 815, and a processor module 820, which each may be in communication, directly or indirectly, with each other (e.g., via one or more buses). The transceiver module 810 is configured to communicate bi-directionally, via the antennas 805 and/or one or more wired or wireless links, with one or more networks, as described above. The transceiver module 810 may include a modem configured to modulate the packets and provide the modulated packets to the antennas 805 for transmission, and to demodulate packets received from the antennas 805. While the mobile device 115-e may include a single antenna, the mobile device 115-e will typically include multiple antennas 805 for multiple links.

The memory 815 may include random access memory (RAM) and read-only memory (ROM). The memory 815 may store computer-readable, computer-executable software code 825 containing instructions that are configured to, when executed, cause the processor module 820 to perform various functions. Alternatively, the software code 825 may not be directly executable by the processor module 820 but be configured to cause the computer (e.g., when compiled and executed) to perform functions described herein.

The processor module 820 may include an intelligent hardware device, e.g., a central processing unit (CPU), a microcontroller, an application-specific integrated circuit (ASIC), etc. The processor module 820 may include a speech encoder (not shown) configured to receive audio via a microphone, convert the audio into packets (e.g., 30 ms in length) representative of the received audio, provide the audio packets to the transceiver module 810, and provide indications of whether a user is speaking. Alternatively, an encoder may only provide packets to the transceiver module 810, with the provision or withholding/suppression of the packet itself providing the indication of whether a user is speaking.

According to the architecture of FIG. 8, the mobile device 115-e may further include a communications management module 830. The communications management module 830 may manage communications with other mobile devices 115. By way of example, the communications management module 830 may be a component of the mobile device 115-e in communication with some or all of the other components of the mobile device 115-e via a bus. Alternatively, functionality of the communications management module 830 may be implemented as a component of the transceiver module 810, as a computer program product, and/or as one or more controller elements of the processor module 820.

In some embodiments, the mobile device 115-e may optionally include a persistent connection refresh module 310-c, which may be an example of the persistent connection refresh module 310 depicted in FIGS. 3, 4, and/or 6. The components of the persistent connection refresh module 310-c to implement the present systems and methods may not be repeated here for the sake of brevity.

In some embodiments, the mobile device 115-e may include a storage module 845. In some cases, the storage module 845 in conjunction with the memory 815 may be configured as a central database, providing the mobile device 115-e and other devices a central storage device to post data and query the data posted by devices. The storage module 845 may include a network identification storage module 850 and a timing schedule storage module 855. The timing schedule storage module 855 may store information identifying an identified timing schedule in the memory 815. The network identification storage module 850 may store information identifying a network associated with the identified timing schedule. Thus, the network identification storage module 850 may store an identifier (ID) of the network. The mobile device 115-e may query the storage module 845 for timeout information of persistent connections on the network, established by one or more applications executing on the mobile device 115-e. The query may be based at least in part on the network ID. Identifying the timing schedule to transmit the keep-alive messages to refresh multiple persistent connections may allow the device 115-e to generate synchronized keep-alive messages for connections and transmit the keep-alive messages over a single radio connection.

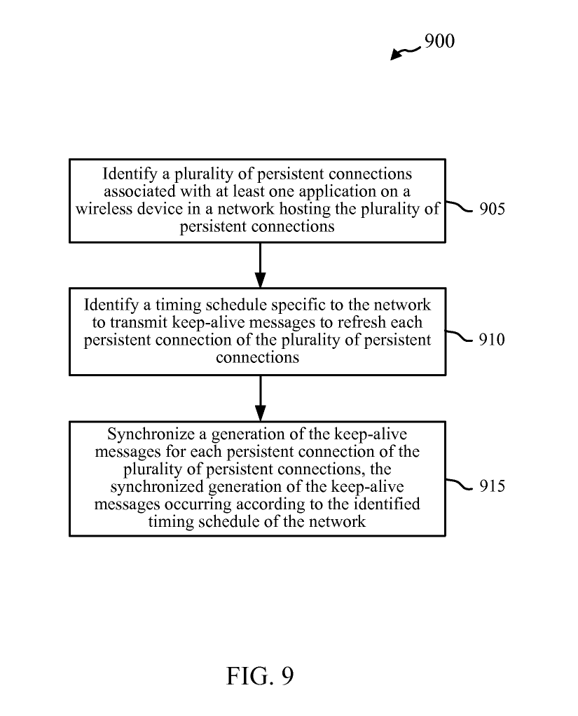

FIG. 9 is a flowchart illustrating one embodiment of a method 900 for synchronizing a transmission of keep-alive messages. For clarity, the method 900 is described below with reference to the device 115 of FIGS. 1, 2, 3, 4, 6, and/or 8. In one implementation, the persistent connection refresh module 310 of FIGS. 3, 4, 6, and/or 8 may execute one or more sets of instructions to perform the functions described below.

At block 905, a plurality of persistent connections associated with at least one application on a wireless device may be identified in a network hosting the plurality of persistent connections. At block 910, a timing schedule may be identified specific to the network. Keep-alive messages may be transmitted according to the identified timing schedule to refresh each persistent connection of the plurality of persistent connections.

At block 915, a generation of the keep-alive messages may be synchronized for each persistent connection of the plurality of persistent connections. The synchronized generation of the keep-alive messages may occur according to the identified timing schedule of the network.

Therefore, the method 900 may provide for synchronizing the generation and transmission of keep-alive messages among a plurality of persistent connections. It should be noted that the method 900 is just one implementation and that the operations of the method 900 may be rearranged or otherwise modified such that other implementations are possible.

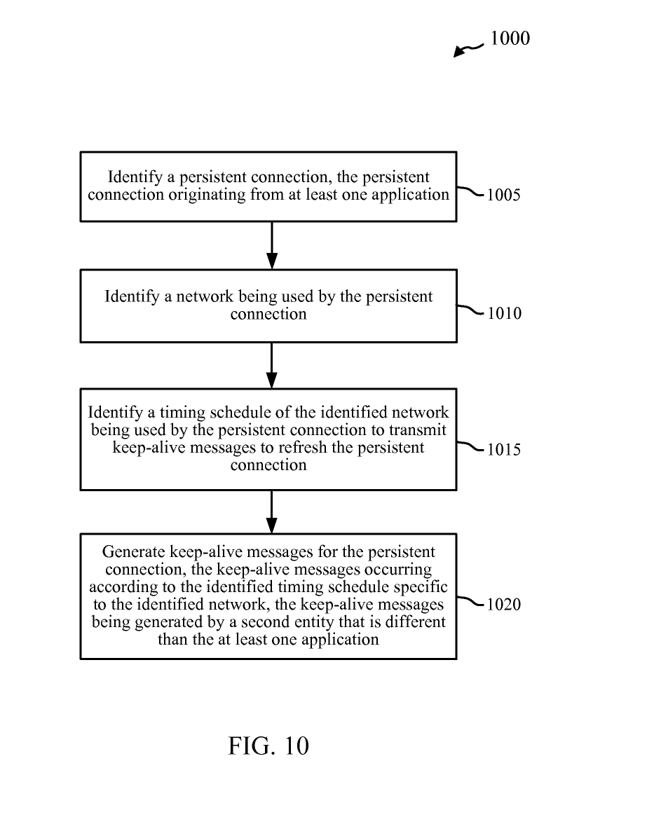

FIG. 10 is a flowchart illustrating one example of a method 1000 for transmitting keep-alive messages for a persistent connection on behalf of an application that originated the persistent connection. For clarity, the method 1000 is described below with reference to the device 115 of FIGS. 1, 2, 3, 4, 6, and/or 8. In one implementation, the persistent connection refresh module 310 of FIGS. 3, 4, 6, and/or 8 may execute one or more sets of instructions to perform the functions described below.

At block 1005, a persistent connection may be identified. The persistent connection may originate from at least one application. At block 1010, a network hosting the persistent connection may be identified. At block 1015, a timing schedule of the identified network hosting the persistent connection may be identified. The timing schedule may be used to transmit keep-alive messages to refresh the persistent connection.

At block 1020, keep-alive messages may be generated for the persistent connection. In one example, the keep-alive messages may be generated and transmitted according to the identified timing schedule of the identified network. In one configuration, the keep-alive messages may be generated by a second entity that is different than the at least one application.

Therefore, the method 1000 may provide for generating keep-alive message for at least one application that originated one or more persistent connections. It should be noted that the method 1000 is just one implementation and that the operations of the method 1000 may be rearranged or otherwise modified such that other implementations are possible.

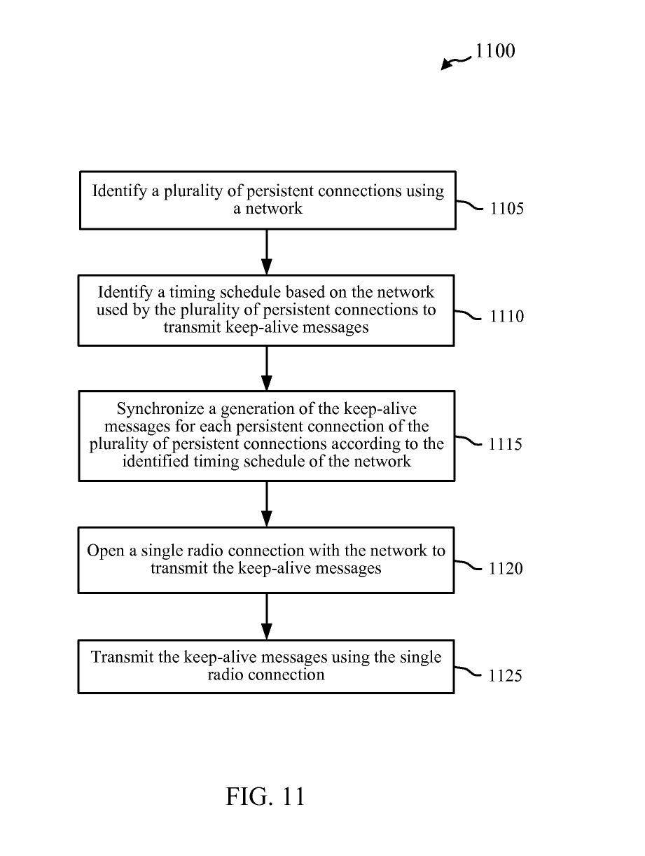

FIG. 11 is a flowchart illustrating one configuration of a method 1100 for transmitting keep-alive messages for a plurality of persistent connections using a single radio connection. For clarity, the method 1100 is described below with reference to the device 115 of FIGS. 1, 2, 3, 4, 6, and/or 8. In one implementation, the persistent connection refresh module 310 of FIGS. 3, 4, 6, and/or 8 may execute one or more sets of instructions to perform the functions described below.

At block 1105, a plurality of persistent connections using a network may be identified. The connections may originate from one or more applications. At block 1110, a timing schedule to transmit keep-alive messages for the connections may be identified. At block 1115, a generation of keep-alive messages for the various connections may be synchronized.

At block 1120, a single radio connection may be opened with the network to transmit the keep-alive messages. In one example, a service (provided, for example, by the persistent connection refresh module 310) that is separate and distinct from the one or more applications may be used to generate the keep-alive messages and open a single radio connection to transmit the keep-alive messages. At block 1125, the keep-alive messages may be transmitted using the single radio connection.

Therefore, the method 1100 may provide for transmitting synchronized keep-alive messages for persistent connections using a single radio connection. It should be noted that the method 1100 is just one implementation and that the operations of the method 1100 may be rearranged or otherwise modified such that other implementations are possible.

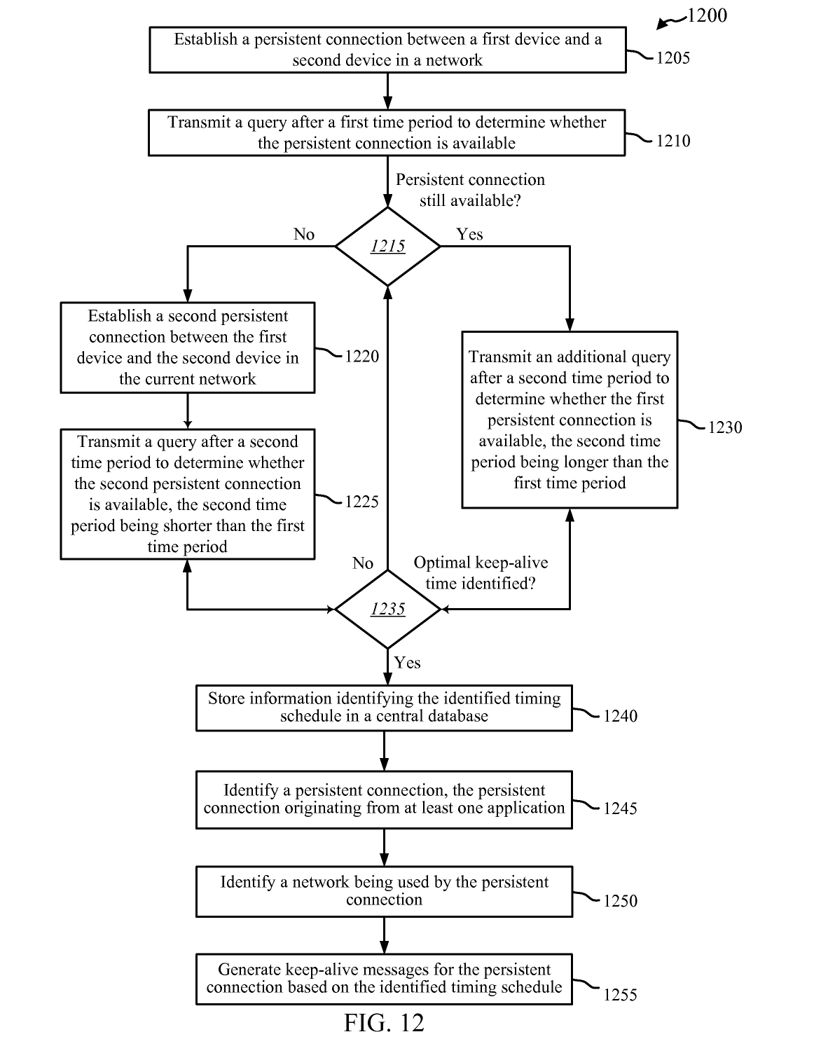

FIG. 12 is a flowchart illustrating one embodiment of a method 1200 for determining a timing schedule for keep-alive messages and the generation of the keep-alive messages according to the timing schedule. For clarity, the method 1200 is described below with reference to the device 115 of FIGS. 1, 2, 3, 4, 6, and/or 8. In one implementation, the persistent connection refresh module 310 of FIGS. 3, 4, 6, and/or 8 may execute one or more sets of instructions to perform the functions described below.

At block 1205 a persistent connection between a first device and a second device in a network may be established. At block 1210, a packet may be transmitted after a first time period and the outcome of the packet transmission may be used to determine whether the persistent connection is available. At block 1215, it may be determined whether the persistent connection is still available. At block 1220, sometime after determining that the persistent connection is not available, a second persistent connection may be established between the first device and the second device in the network.

At block 1225, a packet may be transmitted after a second time period to determine whether the second persistent connection is available. The second time period may be shorter than the first time period. If it is determined, at block 1230, that the persistent connection is available, an additional query may be transmitted after a second time period to determine whether the first persistent connection is available. The second time period may be longer than the first time period.

At block 1235, it may be determined whether an optimal keep-alive time is identified. If the optimal keep-alive time is not identified the method 1200 may return to block 1215. Otherwise, at block 1240, information identifying the identified timing schedule may be stored in a central database. At block 1245, a persistent connection may be identified. The persistent connection may originate from at least one application. At block 1250, a network hosting the persistent connection may be identified. At block 1255, keep-alive messages may be transmitted for the persistent connection based on the identified timing schedule previously determined for the network. In some configurations, a plurality of persistent connections may be identified for which keep-alive messages may be transmitted to keep the plurality of persistent connections alive based on the identified timing schedule previously determined for the network.

Therefore, the method 1200 may provide for determining a timing schedule associated with a persistent connection, storing the determined timing schedule, and generating keep-alive messages based on the determined timing schedule. It should be noted that the method 1200 is just one implementation and that the operations of the method 1200 may be rearranged or otherwise modified such that other implementations are possible.

### Example Time-Out Value Determination

As noted above, stateful middleboxes in a network, such as Network Address Translation (NAT) or Firewalls, may maintain the state of each connection between a user equipment and an application server. In some cases, the state of the NAT or Firewall may be erased after a certain amount of inactivity time, which may be known as a network timeout (NTO) value.

In some scenarios, when the state of the NAT or firewall is erased the transmission control protocol (TCP) connection associated with that NAT or firewall connection may become unusable. This is because the NTO value limits the maximum idle time between received or transmitted packets of the same TCP connection. Thus, it may be desirable to determine NTO values for a traffic synchronization manager or other applications in order to identify a timing schedule for keep-alive messages to prevent unnecessary losses of connection and the wasting of resources. Accordingly aspects of the present disclosure present techniques for passively and dynamically learning NTO values.

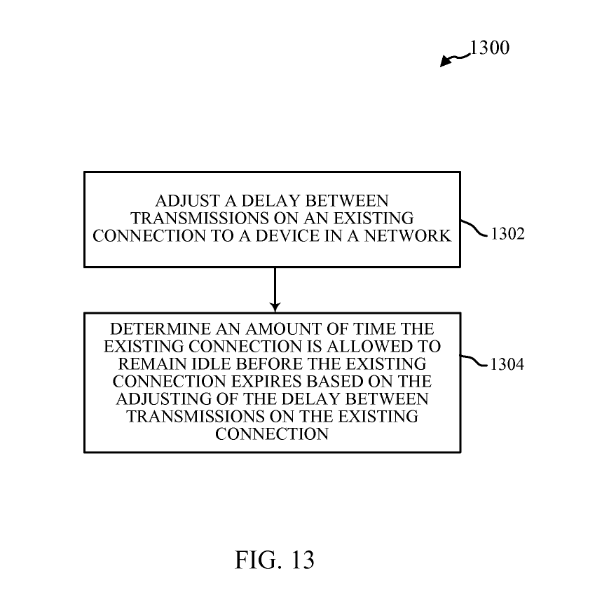

FIG. 13 illustrates example operations 1300 for passively and dynamically determining NTO values in accordance with certain aspects of the present disclosure. The operations 1300 may be performed, for example, by an apparatus capable of communicating in wireless communications system 100 (e.g., UEs 115 and 115a-e illustrated in FIGS. 1-4, 6, and 8).

Operations 1300 begin at 1302 by adjusting an amount of delay applied to transmissions an existing connection to a device in a network. At 1304, the apparatus determines an amount of time the existing connection is allowed to remain idle before the existing connection expires based on the adjusting of the amount of delay applied to the transmissions on the existing connection.

According to certain aspects, the operations 1300 may allow a UE to passively detect NTO values for established connections by using existing connections (e.g., by monitoring transmissions on those existing connection). That is, the UE may passively detect NTO values by analyzing an existing connection and dynamically or iteratively adjusting the amount of delay applied to transmissions on that connection to determine an amount of time the connection may remain idle before the connection is broken.

In some cases, an application layer and transport layer may configure and utilize a certain keep alive interval. A traffic synchronization layer (e.g., Synchronization Module 515 shown in FIG. 5 of the UE 115) may be used to synchronize traffic from the application and transport layers. The synchronization layer may synchronize all traffic, including keep alive messages. Thus, the synchronization layer may not actually modify the keep alive interval configured by the application and transport layers. In other words, the application and transport layers may keep generating keep alive messages at the same interval, but the synchronization layer may determine how much delay before actual transmission it can apply to traffic that is generated by the application and transport layers (adjusting an amount of delay applied to traffic). As far as a receiver can observe, the result is as if the application and transport layers were using a larger keep alive interval.

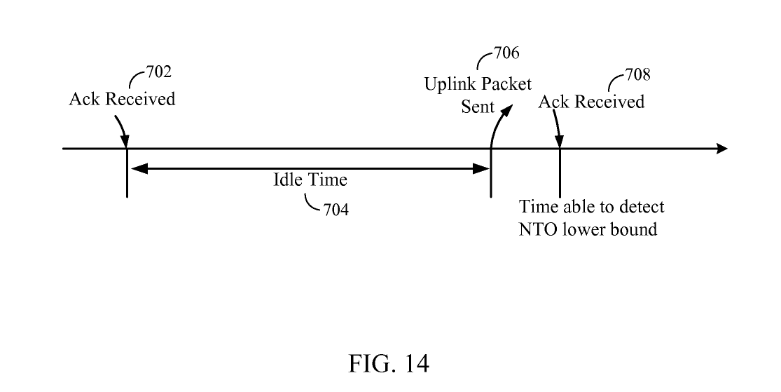

In some cases, a lower bound of an NTO value may be detected. For example, as illustrated by the timeline in FIG. 14, upon being idle/delayed (e.g., connection idle time 704) after reception of a last packet (e.g., ACK 702), a UE may determine that the socket is still alive if the socket transmits data (e.g., uplink packet 706) after the idle time 704 and receives an ACK (e.g., ACK 708) for that transmission. The reception of ACK, sent by the remote side, confirms the availability of the connection. Hence the UE may assume that the NTO value is greater than or equal to this idle time. Thus, this idle time may be considered a lower bound of the NTO. Depending on the implementation, this value may be used as a “known safe” starting point for an algorithm to detect an NTO value. Conversely, when no ACK is received after uplink packet 706, the UE may determine the NTO value is less than the Idle Time 704.

As described above, an apparatus (e.g., a UE) may generate or transmit keep-alive messages for the existing connection based, at least in part, on a detected NTO value. That is, a UE may generate and transmit, on an existing connection, a keep-alive message, with a duration between consecutive keep-alive messages limited by the detected NTO value, to maintain the existing connection.

In some cases, some access networks may use heuristics to erase the state associated with a transport layer connection. So, there may be no strict guarantee that a given connection is always available before the NTO expiration or that the given connection is not available after the NTO expiration. In such networks, instead of learning a single value of NTO, an apparatus may learn a probability that the connection is still available for a given NTO value, based on multiple observations on existing connections. For instance, the apparatus may learn that with an NTO value equal to 5 minutes the connection will survive with 90% probability; with NTO=15 minutes, the connection will survive with 75% probability, etc.

According to certain aspects, a client may request the apparatus to provide an NTO value that ensures the connection is still active with a desired probability.

One advantage of this passive-NTO-detection technique is that by passively detecting NTO values by analyzing its existing connections, the UE may conserve power and resources since the UE does not have to deploy new connections to an application server to detect NTO values.

According to certain aspects, NTO values may be determined per index key, port number, location of a connection, and/or based on any of the aspects discussed above with reference to FIG. 2. In some cases the index key may be associated with the particular domain name of a connection, an application package on the UE, and/or a destination IP prefix (i.e., a range of IP addresses assigned to a particular organization or group). In some cases, learning a domain name may require caching DNS results for a longer period of time than is conventionally needed. Additionally, according to certain aspects, the location information related to the NTO value is used to differentiate between operators of a country or state since these operators may have differing NTO values.

According to certain aspects, NTO values that are learned by the UE may be stored in a database. As noted above, each NTO value entry may be associated with at least one of an NTO index (e.g., an application identity, a domain name, etc.), a port number, a location (e.g., mobile network code, mobile country code, location area code) associated with the NTO value, or a last known good NTO value. According to certain aspects, it may be desirable to be able to push/transmit the database file, or parts of it, for performance testing with the “pre-learned” NTO values. Thus, a UE may receive signaling from a network requesting the database of stored NTO values, and the UE may transmit the database of stored NTO values to the network based on the request. According to certain aspects, the database of stored NTO values may be used in various ways. For example, based on the database of NTO values, an application publisher could be notified that their firewall NTO value for a particular application is too short. As another example, an operator could be notified that their NTO is too short for a particular location. After learning a valid NTO value associated with a NTO index, the device may report it to a central server, such as a server used for crowd sourcing. Such a central server may provide this NTO index and value to other devices.

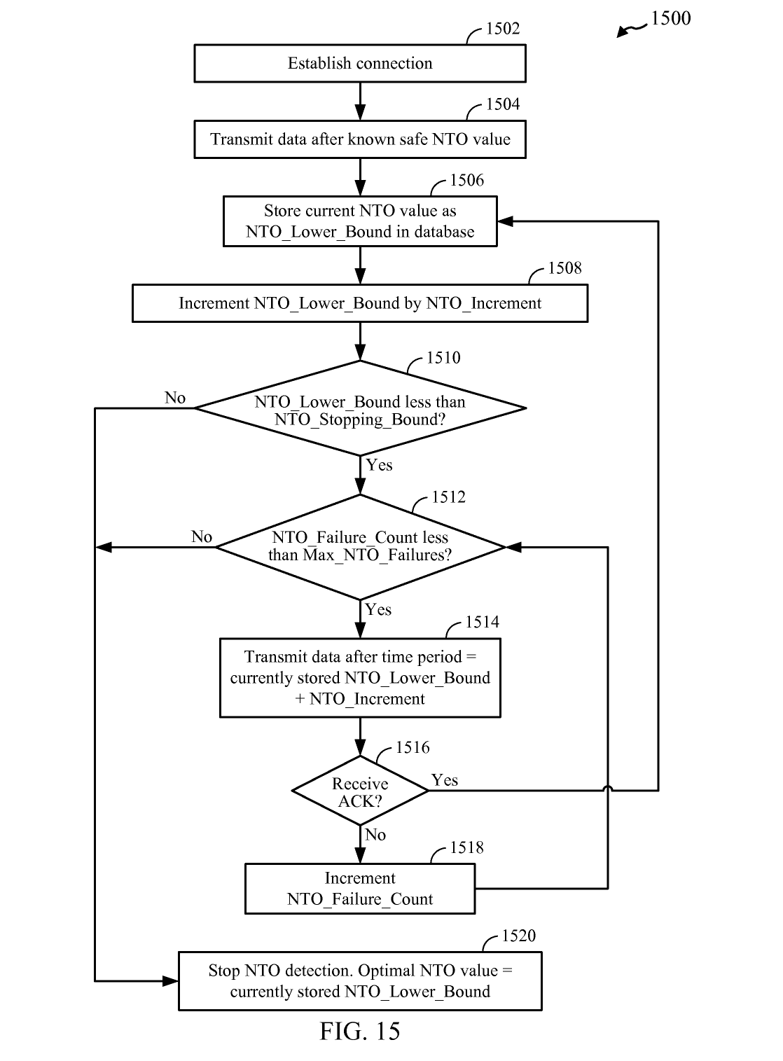

FIG. 15 is a flowchart illustrating a method for (e.g., passively and) dynamically determining NTO values, in accordance with certain aspects of the present disclosure. That is, FIG. 15 illustrates a flowchart for determining an amount of time a connection may be idle while still remaining “alive” (i.e., active, or, for which the connection is not lost/broken). According to certain aspects, the method illustrated in FIG. 15 may correspond to operations 1300 illustrated in FIG. 13.

At block 1502, a connection (e.g., a persistent connection) between a first device (e.g., UE 115) and a second device (e.g., middlebox 620) may be established. To begin detecting the NTO value for the established connection, at block 1504, the first device may transmit data at known safe NTO value (e.g., 5 minutes). According to certain aspects, a known safe NTO value may be set by an operator of the network (e.g., the default MNC/MCC) in which the connection exists, and is a time at which it is known with certainty that the connection is still alive/active. When no value is provided by the operator, a small value of NTO may be used, such as 30 seconds.

At block 1506, the first device may store the current NTO value (i.e., for a first iteration, the known safe NTO value, and for subsequent iterations, an NTO value for which an ACK is received in response to data transmitted). The current NTO value may be stored in a local database, and may be referred to as the NTO lower bound (NTO_Lower_Bound). As noted above, each stored NTO value entry may be associated with at least one of an NTO index (e.g., an application identity, a domain name, etc.), a port number, a location (e.g., mobile network code, mobile country code, location area code) associated with the NTO value, a last known good NTO value, and/or based on any of the aspects discussed above with reference to FIG. 2.

At 1508, the first device may increment the currently stored NTO value (NTO_Lower_Bound) by an NTO increment value (NTO_Incrememnt). According to certain aspects, the NTO increment value may be any value above zero (e.g., 1 min) The purpose of NTO increment value is to extend the idle time between the last known good NTO value (i.e., an NTO value for which an ACK was received by the first device) and when data will be transmitted again on the established connection. By iteratively increasing the NTO value by NTO increment value, an optimal NTO value may be determined, which represents the maximum amount of time a connection may remain idle, without being broken.

At 1510, if the value of NTO_Lower_Bound+NTO_Increment is less than a maximum NTO value (NTO_Stopping_Bound), which may be set by the operator of the network (e.g., a specific value set by the MNC/MCC), the first device may move to block 1512. If, however, the value NTO_Lower_Bound+NTO_Increment is greater than or equal to the maximum NTO value, NTO detection may be stopped at block 1520, and the currently stored NTO value may be assumed to be the optimal NTO value.

At 1512, if an NTO failure count (NTO_Failure_Count) is less than a maximum number of allowable NTO failures (Max_NTO_Failures), the first device may move to block 1514. If, however, the NTO failure count is greater than or equal to the maximum number of allowable NTO failures, NTO detection is stopped at block 1520, and the currently stored NTO value may be assumed to be the optimal NTO value. According to certain aspects, the NTO failure count represents the number of times a transmission of data (associated with the NTO detection) fails to receive an acknowledgement (ACK) in response. According to certain aspects, the value of the maximum number of allowable NTO failures may be defaulted to a value of 1, but may be set to any value greater than or equal to 1. According to certain aspects, when Max_NTO_Failures is reached, a maximum NTO may be set to the current idle time (e.g., idle time 704)

At 1514, the first device may delay the transmission of data for a time period of NTO_Lower_Bound+NTO_Increment and then transmit data on the established connection.

At 1516, if, after the connection remains idle for the time period of NTO_Lower_Bound+NTO_Incrememnt, the first device receives an ACK from the network in response to the data transmission at 1514, the first device may implicitly know that the NTO value for that connection is equal to or greater than the current NTO_Lower_Bound+NTO_Increment. Thus, if at 1516, the first device receives and ACK in response to the data transmission at 1514, the first device may return to block 1506 and store the current NTO value (i.e., NTO_Lower_Bound+NTO_Increment). However, at 1516, if the first device does not receive an ACK in response to the data transmission at 1514, the first device may increment an NTO failure counter (NTO_Failure_Count) at 1518. The first device may then return to block 1512 and re-transmit data at the same NTO value (i.e., the currently stored NTO value) that triggered the NTO failure in order to test whether the NTO failure is a true NTO failure or was caused by something else, such as poor signal.

According to certain aspects, the method illustrated in FIG. 15 may be used to determine an NTO value for a particular existing connection between an apparatus and a device in a network. However, this NTO value may only remain valid for a certain period of time. Thus, according to certain aspects, NTO detection may need to be repeated after a certain period of time for those NTO values that were determined as a result of an NTO failure. According to certain aspects, NTO detection for those NTO values that were determined as a result of an NTO failure may be repeated after thirty days or some other period of time. According to certain aspects, when repeating NTO detection for a particular existing connection, the process may begin at the currently stored NTO value for that connection plus the NTO increment value.

While the above techniques have been described with reference to passively and dynamically determining network time out values, it should be understood that these techniques may also generally be used to determine other values pertaining to, or used by, the network (e.g., by iteratively modifying certain values until a failure occurs).

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting (or outputting) may comprise a transmitter (e.g., the transceiver module 810) and/or an antenna(s) 805 of the user equipment 115-e illustrated in FIG. 8. Means for receiving (or obtaining) may comprise a receiver (e.g., the transceiver module 810) and/or an antenna(s) 805 of the user equipment 115-e illustrated in FIG. 8.

Means for generating, means for determining, and means for adjusting may comprise a processing system, which may include one or more processors, such as the processor module 820 of the user equipment 115-e illustrated in FIG. 8.

According to certain aspects, such means may be implemented by processing systems configured to perform the corresponding functions by implementing various algorithms (e.g., in hardware or by executing software instructions) described above.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal 115 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer readable storage medium with instructions stored thereon separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by an apparatus such as the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of detecting a network timeout (NTO) value by an apparatus, comprising:
adjusting an amount of delay applied to transmissions on an existing connection to a device in a network; and
determining an amount of time the existing connection is allowed to remain idle before the existing connection expires based on the adjusting of the amount of delay applied to the transmissions on the existing connection.

2. The method of claim 1, wherein the determining comprises:
monitoring an idle time between previous and current transmissions from the apparatus to the device; and
monitoring for reception of acknowledgements (ACKs) associated with the transmissions.

3. The method of claim 2, wherein the determining comprises determining a lower bound on the NTO value based on the monitored idle time and ACKs, an upper bound when an ACK is not received, or a combination thereof.

4. The method of claim 2, further comprising associating an NTO value with a probability of successfully maintaining the existing connection after the idle time.

5. The method of claim 1, further comprising updating an NTO value associated with the network, based at least in part, on the determination.

6. The method of claim 1, wherein the determining comprises:
iteratively increasing a time period between the transmissions from the apparatus to the device until an acknowledgement (ACK) is not received for one of the transmissions, and further determining that the NTO value of the network is equal to a greatest idle interval sampled where an ACK is received.

7. The method of claim 6, further comprising:
initializing the time period between the transmissions to a value that is expected to be less than an actual NTO value of the network.

8. The method of claim 6, wherein iteratively increasing the time period between the transmissions is subject to a maximum bound on the time period.

9. The method of claim 8, wherein the maximum bound is set by at least one of an operator of the network or by an upper bound on the NTO value determined based on when an ACK is not received.

10. The method of claim 6, wherein the NTO value is determined after multiple transmissions, with the same time period between each transmission, are sent without receiving an ACK.

11. The method of claim 1, further comprising storing a detected NTO value in a database.

12. The method of claim 11, further comprising:
receiving a request to transmit information from the database to the network; and
transmitting the information from the database to the network in response to the request.

13. The method of claim 11, wherein the NTO value is stored in an entry in the database with information relating to at least one of an NTO index, a port number, a location, a last known good NTO value, an internet protocol version, transport protocol type, destination port number, a destination server identifier, a public land mobile network (PLMN) identity, a mobile country code (MCC), a mobile network code (MNC), a tracking area, an internet protocol (IP) address or IP address prefix, or graphical coordinates, or a network identifier.

14. The method of claim 13, wherein the network identifier comprises a MAC address or a Cell Identifier.

15. The method of claim 11, further comprising downloading information in a database of detected NTO values from the network.

16. The method of claim 1, further comprising providing the NTO value to an application for use in determining when to send keep-alive messages.

17. The method of claim 1, further comprising:
repeating detection of the NTO value after an NTO validity time has passed if the NTO value was determined as a result of no ACK being received by the apparatus.

18. An apparatus for detecting a network timeout (NTO) value, comprising:
at least one processor configured to adjust an amount of delay applied to transmissions on an existing connection to a device in a network and determine an amount of time the existing connection is allowed to remain idle before the existing connection expires based on the amount of delay applied to the transmissions on the existing connection; and
a memory coupled with the at least one processor.

19. The apparatus of claim 18, wherein, to determine the amount of time the existing connection is allowed to remain idle, the at least one processor is configured to:
monitor an idle time between previous and current transmissions from the apparatus to the device; and
monitor for reception of acknowledgements (ACKs) associated with the transmissions.

20. The apparatus of claim 19, wherein the at least one processor configured to determine a lower bound on the NTO value based on the monitored idle time and ACKs, an upper bound when an ACK is not, or a combination thereof.

21. The apparatus of claim 18, wherein the at least one processor is further configured to update an NTO value associated with the network, based at least in part, on the determination of the amount of time the existing connection is allowed to remain idle before the existing connection expires.

22. The apparatus of claim 18, wherein the at least one processor is further configured to:
iteratively increase a time period between the transmissions from the apparatus to the device until an acknowledgement (ACK) is not received for one of the transmissions, and further determine that the NTO value of the network is equal to a greatest idle interval sampled where an ACK is received.

23. The apparatus of claim 22, wherein the NTO value is determined after multiple transmissions, with the same time period between each transmission, are sent without receiving an ACK.

24. The apparatus of claim 18, wherein the at least one processor is further configured to store a detected NTO value in a database.

25. The apparatus of claim 24, wherein the at least one processor is further configured to:
receive a request to transmit information from the database to the network; and
transmit the information from the database to the network in response to the request; or
download information in a database of detected NTO values from the network.

26. The apparatus of claim 24, wherein the NTO value is stored in an entry in the database with information relating to at least one of an NTO index, a port number, a location, a last known good NTO value, an internet protocol version, transport protocol type, destination port number, a destination server identifier, a public land mobile network (PLMN) identity, a mobile country code (MCC), a mobile network code (MNC), a tracking area, an internet protocol (IP) address or IP address prefix, or graphical coordinates, or a network identifier.

27. The apparatus of claim 18, wherein the at least one processor is further configured to provide the NTO value to an application for use in determining when to send keep-alive messages.

28. The apparatus of claim 18, wherein the at least one processor is further configured to:
repeat detection of the NTO value after an NTO validity time has passed if the NTO value was determined as a result of no ACK being received by the apparatus.

29. An apparatus for detecting a network timeout (NTO) value, comprising:
means for adjusting an amount of delay applied to transmissions on an existing connection to a device in a network; and
means for determining an amount of time the existing connection is allowed to remain idle before the existing connection expires based on the adjusting of the amount of delay applied to the transmissions on the existing connection.

30. A computer-readable medium for detecting a network timeout (NTO) value, the computer-readable medium having instructions stored thereon for:
adjusting an amount of delay applied to transmissions on an existing connection to a device in a network; and
determining an amount of time the existing connection is allowed to remain idle before the existing connection expires based on the adjusting of the amount of delay applied to the transmissions on the existing connection.
